(19) United States
(12) Patent Application Publication
(10) Pub. No.: US 2005/0085935 A1
(43) Pub. Date: Apr. 21, 2005

(54) Audio system

(75) Inventor: Takashi Ide, Hyogo (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/962,620

(22) Filed: Oct. 13, 2004

(30) Foreign Application Priority Data
Oct. 15, 2003 (JP) P2003-355063

(51) Int. Cl. G06F 17/00

(52) U.S. Cl. 700/94

(57) ABSTRACT

An audio system according to the present invention comprises a drive unit for outputting multiplexed data comprised of audio data and file information, a network transmission unit for transmitting network data, in which the inputted multiplexed data is converted into a transfer format, and automatically correcting a variation between input and output cycles, a network reception unit for inversely format-converting the received network data and automatically correcting a variation between input and output cycles, and an amplifier unit for inputting the multiplexed data from the network reception unit and reducing an analogue output level until the completion of a setting change of the file information when a change is detected in the file information, wherein the audio data is seamlessly reproduced.

### BACKGROUND OF THE INVENTION

1. Field of the Invention

The present invention relates to an audio system for transmitting audio data from a drive unit of a recording medium to an amplifier unit via a network and reproducing the audio data, more particularly to a technology for seamlessly reproducing the audio data in such manner as controlling a sound jump in the case of a quantization bit number and a sampling frequency being different in each music, as in audio data such as DVD.

2. Description of the Related Art

In the case of CD audio, file information, such as a quantization bit number and a sampling frequency, is constant. Therefore, there is no particular arrangement required for transferring such audio data to a network. However, in the case of the file information being different per music, as in DVD audio, the following process is required every time the file information is changed.

1) A drive unit issues a mute processing order with respect to an amplifier unit in order to prevent a noise sound.

2) The amplifier unit notifies the drive unit of the completion of the mute processing.

3) The drive unit notifies the amplifier unit of the file information in audio data to be transmitted.

4) The amplifier unit notifies the drive unit that the audio data can be now received, and cancels the mute processing.

5) The drive unit transmits the audio data to the amplifier unit.

In the foregoing process, it is necessary to halt the transmission of the audio data every time the file information changes, which is inefficient. Further, when the drive unit or the amplifier unit is not entirely in synchronization with a data transfer cycle in the network, the noise sound caused by a missing sound, or the like, is generated from a speaker of the amplifier unit. The noise sound is also generated from any abnormality present in the transmission/reception of the audio data due to a communication fault in the network.

Therefore, it is desirable to be able to seamlessly reproduce the audio data without any influence from the changing file information. It is also desirable to prevent the noise sound despite any communication fault generated in the network.

### BRIEF SUMMARY OF THE INVENTION

An audio system according to the present invention comprises:
a drive unit for reading audio data and file information including a quantization bit number and a sampling frequency from a recording medium, such as a DVD disc, multiplexing the read audio data and file information, and serially outputting the multiplexed data;
a network transmission unit comprising a function for creating network data by converting the multiplexed data serially inputted from the drive unit into a required transfer format and transmitting the network data to the network, the network transmission unit further comprising a function for verifying a variation between a cycle of the reception from the drive unit and a cycle of the transmission to the network and automatically correcting the variation between the cycles when the presence of the variation is detected;
a network reception unit comprising a function for creating multiplexed data by inversely format-converting the network data received from the network transmission unit and serially outputting the multiplexed data, the network reception unit further comprising a function for verifying a variation between a cycle of the reception from the network and a cycle of the transmission of the multiplexed data and automatically correcting the variation between the cycles when the presence of the variation is detected; and
an amplifier unit for dividing the multiplexed data serially inputted from the network reception unit into the audio data and the file information, converting the audio data into an analogue signal, verifying a change of the file information, and reducing an analogue output level until the completion of a setting change of the file information when the presence of the change is detected.

According to the foregoing configuration, when the audio data is transmitted/received via the network, it becomes unnecessary to halt the transmission of the audio data every time when the quantization bit number and/or sampling frequency, which are factors determining a sound quality, changes. The audio data can be seamlessly transmitted and reproduced through the automatic correction of the variation between the input and output cycles. More specifically, when the drive unit or the amplifier unit is not entirely in synchronization with the data transfer cycle in the network or when the communication fault is generated in the network, the audio data can be correctly transmitted/received between the drive unit and the amplifier unit, and the noise sound can be prevented in the speaker in the amplifier unit.

Additional objects and advantages of the present invention will be apparent from the following detailed description of preferred embodiments thereof, which are best understood with reference to the accompanying drawings.

### BRIEF DESCRIPTION OF THE DRAWINGS

FIG. 1 illustrates a schematic configuration of an audio system according to an embodiment 1 of the present invention.

FIG. 2 illustrates a schematic configuration of a serial transmission circuit according to the embodiment 1.

FIG. 3 illustrates a configuration of a data signal according to the embodiment 1.

FIG. 4 illustrates a format of communication data according to the embodiment 1.

FIG. 5 illustrates a configuration of a data signal according to an embodiment 2 of the present invention.

FIG. 6 illustrates a configuration of a data signal according to an embodiment 3 of the present invention.

FIG. 7 illustrates a (first) configuration of a synchronous signal according to the embodiment 3.

FIG. 8 illustrates a (second) configuration of a synchronous signal according to the embodiment 3.

FIG. 9 illustrates a configuration of a data signal according to an embodiment 4 of the present invention.

FIG. 10 illustrates a configuration of a data signal according to an embodiment 5 of the present invention.

FIG. 11 illustrates a configuration of a data signal according to an embodiment 6 of the present invention.

FIG. 12 illustrates a schematic configuration of a serial reception circuit according to the embodiment 1.

FIG. 13 illustrates a schematic configuration of a transfer data creation circuit according to the embodiment 1.

FIG. 14 is a (first) time chart illustrating an operation of the transfer data creation circuit according to the embodiment 1.

FIG. 15 is a (second) time chart illustrating an operation of the transfer data creation circuit according to the embodiment 1.

FIG. 16 is an illustration of an audio data transmission method according to a conventional technology.

FIG. 17 is an illustration of an audio data transmission method according to the embodiment 1.

FIG. 18 illustrates a configuration of control information according to the embodiment 1.

FIG. 19 illustrates a schematic configuration of a network system according to the embodiment 1.

FIG. 20 illustrates a (first) control flow of the network according to the embodiment 1.

FIG. 21 illustrates a (second) control flow of the network according to the embodiment 1.

FIG. 22 illustrates a schematic configuration of a data creation circuit according to the embodiment 1.

FIG. 23 is a (first) time chart illustrating an operation of the data creation circuit according to the embodiment 1.

FIG. 24 is a (second) time chart illustrating an operation of the data creation circuit according to the embodiment 1.

FIG. 25 illustrates a schematic configuration of a serial reception circuit according to the embodiment 1.

FIG. 26 illustrates a schematic configuration of an amplifier unit according to the embodiment 1.

In all these figures, like components are indicated by the same numerals.

### DETAILED DESCRIPTION OF THE PREFERRED EMBODIMENTS

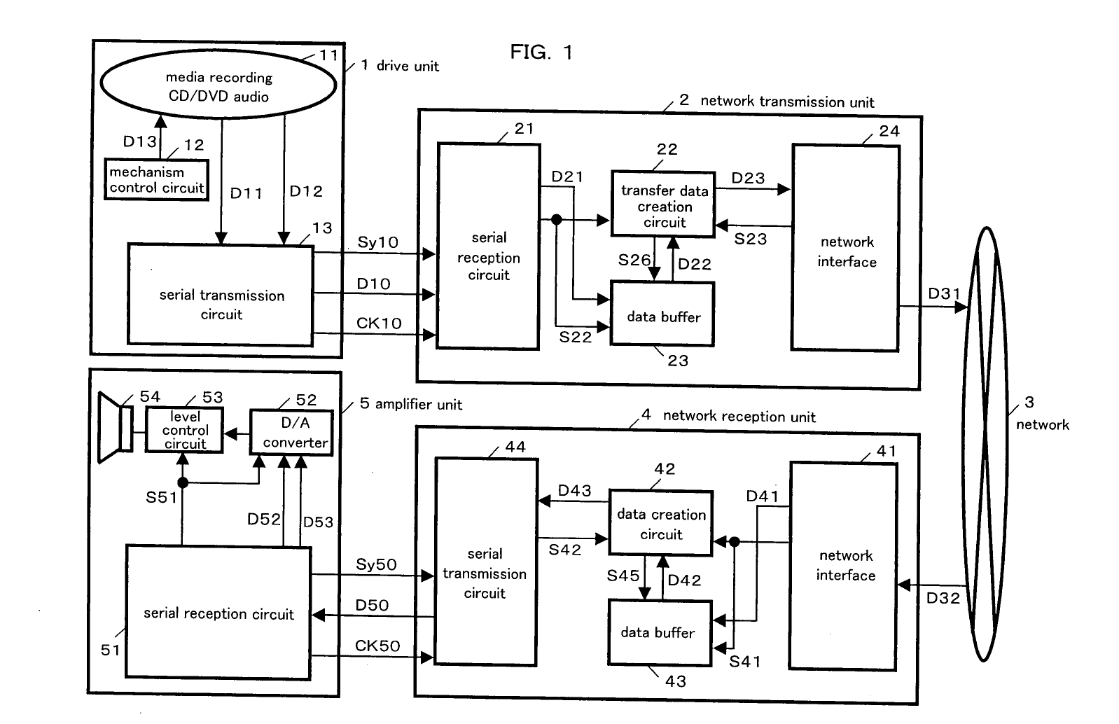

Hereinafter, preferred embodiments of the present invention are described referring to the drawings. In FIG. 1 showing a configuration of an audio system, referring to respective reference numerals, 1 denotes a drive unit of a recording medium, 2 denotes a network transmission unit, 3 denotes a network, 4 denotes a network reception unit, and 5 denotes an amplifier unit.

The drive unit 1 comprises a mechanism control circuit 12 and a serial transmission circuit 13. The mechanism control circuit 12 drives a recording medium 11, in which CD or DVD audio is recorded, by means of control information D13. The mechanism control circuit 12 further reads audio data D11 and file information D12 such as a quantization bit number and a sampling frequency required for the reproduction of the audio data D11. The serial transmission circuit 13 inputs the audio data D11 and the file information D12 to thereby create a synchronous signal Sy10, communication data D10 and further a clock for transfer CK10.

The network transmission unit 2 comprises a serial reception circuit 21, a transfer data creation circuit 22, a data buffer 23, and a network interface 24. The serial reception circuit 21 receives the synchronous signals Sy10, communication data D10, and clock CK 10 outputted from the drive unit 1. The data buffer 23 stores the received data. The transfer data creation circuit 22 creates transfer data D23 to be transferred to the network 3. The interface 24 converts the transfer data D23 into a transfer format suitable for a protocol of the network 3 and transmits the format-converted transfer data D23 to the network 3. The transfer data creation circuit 22 inputs a write signal S22 from the serial reception circuit 21 and a read signal S23 from the interface 24. The transfer data creation circuit 22, through the comparison of the both signals, accesses the data buffer 23 by means of a buffer read signal S26 judging the right timing to do so to thereby read buffer data D22, and creates and outputs the transfer data D23 after a necessary processing is executed thereto when any transfer abnormality is predicted.

The network reception unit 4 comprises a network interface 41, a data creation circuit 42, a data buffer 43, and a serial transmission circuit 44. The interface 41 inversely format-converts network data D32 received from the network, and then extracts the audio data and the file information to thereby create transfer data D41 in which the audio data and the file information are multiplexed. The data buffer 43 stores the transfer data D41. The data creation circuit 42 creates data D43 to be transferred from buffer data D42 to the amplifier unit 5. The serial transmission circuit 44 creates communication data D50 from the data D43. Here, the network transmission unit 2 and the network reception unit 4 operate in synchronization with the network 3. The data creation circuit 42 inputs a write signal S41 from the interface 41 and a read signal S42 from the serial transmission circuit 44. The data creation circuit 42, through the comparison of the both signals, accesses the data buffer 43 by means of a buffer read signal S45 judging the right timing to do so to thereby read buffer data D42, and creates and outputs the transfer data D43 after a necessary processing is executed thereto when any transfer abnormality is predicted.

The amplifier unit 5 comprises a serial reception circuit 51, a D/A converter 52, a level control circuit 53, and a speaker 54. The serial reception circuit 51 supplies a synchronous signal Sy50 and a clock for transfer CK50 to the serial transmission circuit 44 of the network reception unit 4. The serial reception circuit 51 further receives communication data D50 from the serial transmission circuit 44, divides it into audio data D52 and file information D53, and inputs the audio data D52 and the file information D53 to the D/A converter 52. The D/A converter 52 sets a quantization bit number and a sampling frequency necessary for reproduction in the provided file information D53. The serial reception circuit 51 asserts a change-detection signal S51 when the file information changes and outputs the signal S51 to the level control circuit 53. When the change-detection signal S51 is asserted, the level control circuit 53 reduces an analogue output level until the setting change of the file information D53 is completed. In that manner, any noise sound generated during the time when the file information D53 is changed can be prevented from being outputted from the speaker 54.

Here, the network transmission unit 2, network 3, and network reception unit 4 operate based on an identical clock on principle. However, a slight variation can be possibly generated in phases or frequencies due to an influence from a frequency deviation, or the like. Further, a slight variation can be possibly generated between cycles of the inputted data and outputted data in the network transmission unit 2 and the network reception unit 4.

Hereinafter, specific embodiments of the present invention are described referring to the drawings.

Embodiment 1

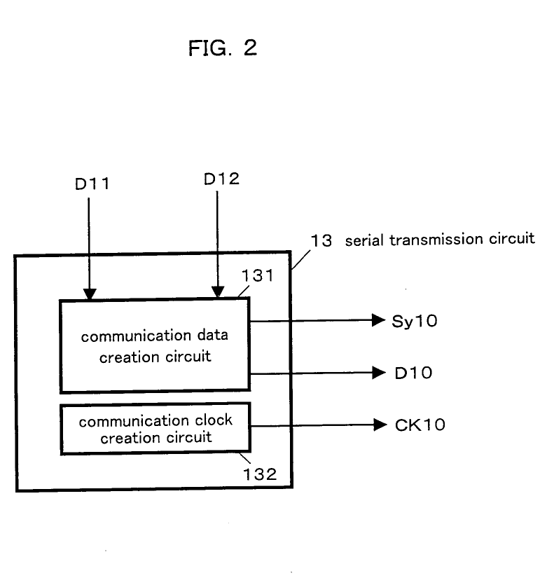

A serial transmission circuit 13 shown in FIG. 2 comprises a communication data creation circuit 131 and a communication clock creation circuit 132. The communication data creation circuit 131 inputs the audio data D11 and the file information D12 to thereby create the synchronous signal Sy10 and the communication data D10. The communication clock creation circuit 132 creates the clock CK 10 for the data transfer.

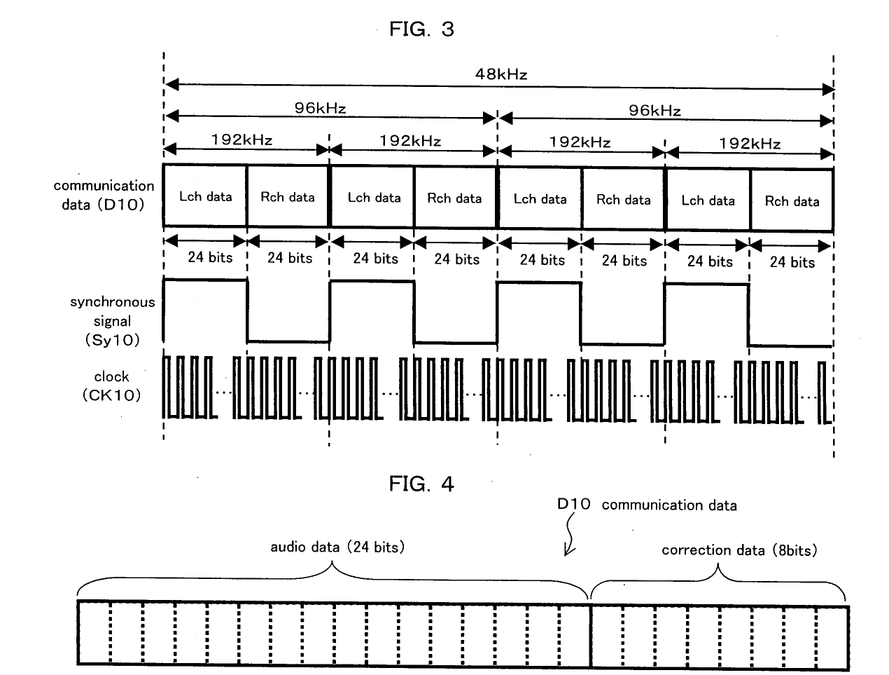

FIG. 3 illustrates the communication data D10, synchronous signal Sy10, and clock CK 10, which are created in the serial transmission circuit 113. In the DVD audio, the quantization bit number is differently set, per music to be stored in the recording medium 11, to 16 bits, 20 bits, or 24 bits. In the present example, the quantization bit number is uniformly 24 bits. Accordingly, when the audio data of 16 bits in quantization bit number is transmitted, an eight-bit correction is executed to the data, as shown in FIG. 4, to thereby create the communication data D10 extended to 24 bits in quantization bit number. “0” is embedded in the corrected data.

The communication data D10 in the present example is comprised of L channel data and R channel data for stereo output. The synchronous signal Sy10 is inverted in polarity in response to the L channel data or the R channel data. Waveforms of the synchronous signal Sy10 and the communication data D10 shown in FIG. 3 are only an example, and no limitation to such a format is necessary.

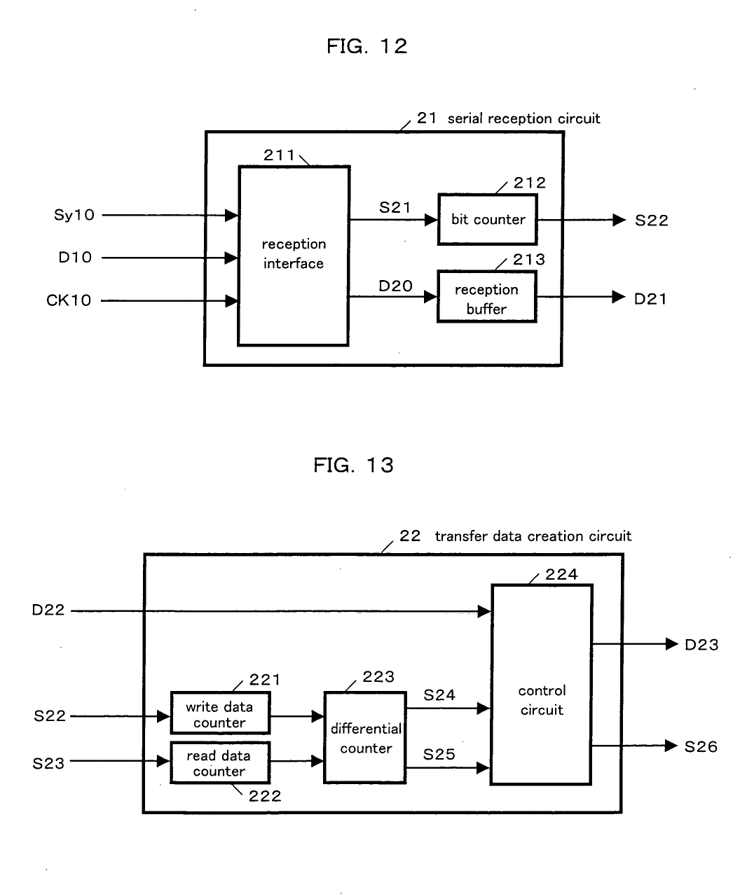

A serial reception circuit 21 shown in FIG. 12 comprises a reception interface 211, a bit counter 212, and a reception buffer 213. The reception interface 211 inputs the synchronous signal Sy10, communication data D10, and clock CK 10 outputted from the drive unit 1 to thereby receive multiplexed data. The reception interface 211 outputs a count-up enable S21 every time when the data is received for one bit to thereby make the bit counter 212 count up the bits. The bit counter 212 outputs the write signal S22 for storing the received multiplexed data to the data buffer 23 when the reception of the L channel data and the R channel data of the communication data D10 is completed. The reception buffer 213 stores reception data D20, and outputs data D21 to the data buffer 23.

A transfer data creation circuit 22 shown in FIG. 13 comprises a write data counter 221, a read data counter 222, a differential counter 223, and a control circuit 224. The write data counter 221 detects the assertion of the write signal S22 outputted from the serial reception circuit 21, and counts a volume of the reception data written in the data buffer 23. The read data counter 222 detects the assertion of the read signal S23 outputted from the interface 24, and counts a volume of the data read from the data buffer 23. The differential counter 223 calculates a differential between the count value of the write data counter 221 and the count value of the read data counter 222. The differential counter 223 further asserts a write-over signal S24 when the count value of the write data counter 221 is larger than the count value of the read data counter 222 by certain level or more, and asserts a read-over signal S25 when the count value of the read data counter 222 is larger than the count value of the write data counter 221. The control circuit 224 inputs the buffer data D22, write-over signal S24, and read-over signal S25 to thereby create and output the transfer data D23 and the buffer read signal S26.

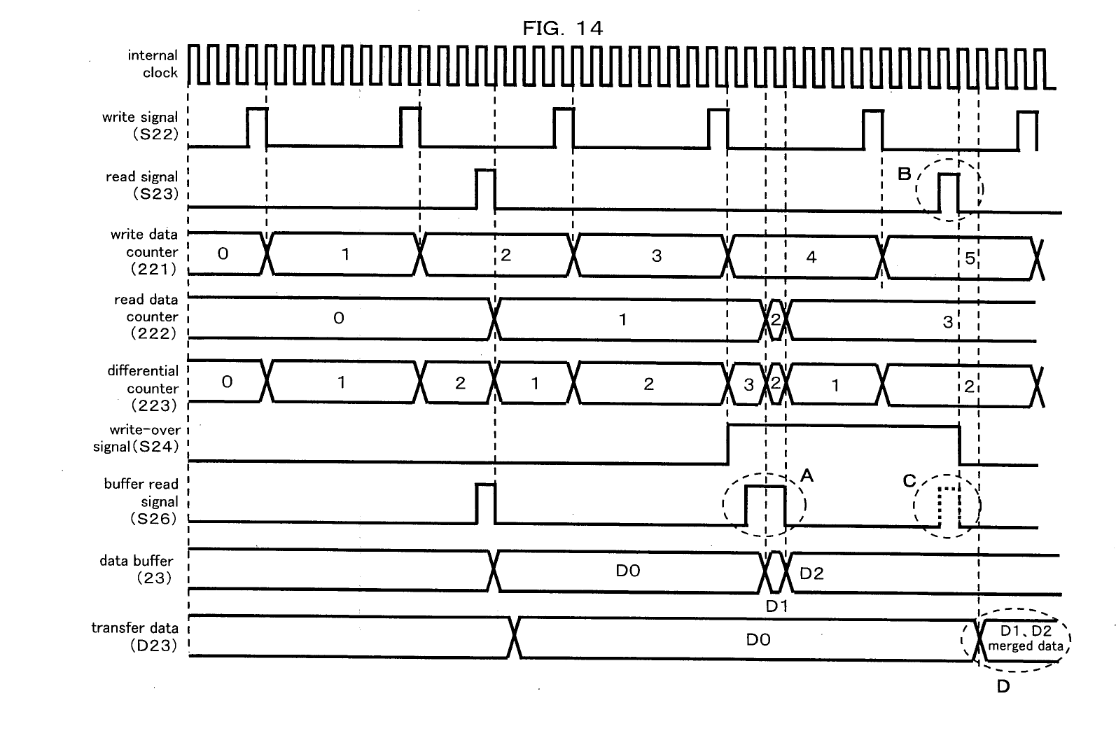

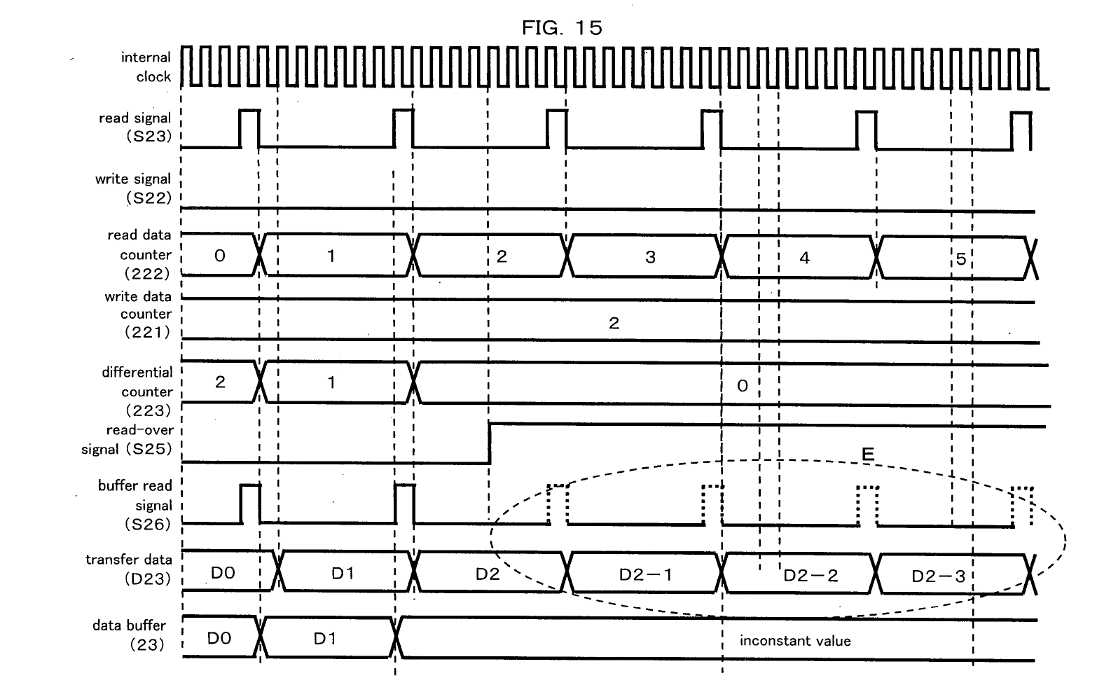

Below is described an operation of the control circuit 224 referring to FIGS. 14 and 15. A clock used in the following description is an operation clock of the transfer data creation circuit 22.

FIG. 14 shows the case, where a cycle in which the serial reception circuit 21 writes the data in the data buffer 23 is shorter than a cycle in which the interface 24 reads the data from the data buffer 23. This is the phenomenon generated when there is a variation between a cycle of the transfer clock CK10 created by the drive unit 1 and a cycle of the clock of the network 3 due to a frequency deviation, or the like. The drawing shows the state where there is a large variation between a cycle of the write signal S22 and a cycle of the read signal S23 to simplify the description.

The write data counter 221 and the read data counter 222 are respectively incremented when the write signal S22 and the read signal S23 are asserted. In the present case, because the read signal S23 is asserted less often than the write signal S22, a writing overflow will be sooner or later generated in the data buffer 23. Therefore, when the count value of the differential counter 223 is equal to or more than a certain level, the differential counter 223 outputs the write-over signal S24. The control circuit 224 receives the write-over signal S24 and creates the buffer read signal S26 to thereby read the buffer data D22 from the data buffer 23, and merges the read data. In FIG. 14, the write-over signal S24 is created when the count value of the differential counter 223 reaches “3”, the data buffer 23 is read-accessed twice. A point A shows that two additional buffer read signals S26 are created. In the absence of the read signal S23, the count value of the read data counter 222 proceeds to “2”, “3”, and the count value of the differential counter 223 accordingly decreases to “2”, “1”. Data “D1” and “D2” are read from the data buffer 23. The two data D1 and D2 are summed and then divided by “2” to be thereafter merged, which means the substantial reduction of the sampling frequency to a half. The method of the merger is not limited to the method described above.

Meanwhile, when the next read signal S23 is asserted at a point B, the merged data is outputted as the transfer data D23 at a point D. At that time, as shown at a point C, the buffer read signal S26 is masked by means of the write-over signal S24 to thereby halt an ordinary data output from the data buffer 23.

Then, the write-over signal S24 is negated in response to the assertion of the read signal S23, thereby returning to a normal operation.

As described, the merger of the audio data substantially reduces the sampling frequency so that the generation of the writing overflow in the data buffer 23 can be prevented.

FIG. 15 shows the case, where the cycle in which the serial reception circuit 21 writes the data in the data buffer 23 is longer than the cycle in which the interface 24 reads the data from the data buffer 23. This is the phenomenon generated when there is a variation between the cycle of the transfer clock CK10 created by the drive unit 1 and the cycle of the clock of the network 3 due to the frequency deviation, or the like. The same phenomenon occurs when it becomes impossible for the multiplexed data to be transmitted from the drive unit 1 due to some kind of factor. The drawing shows the state where there is a large variation between the cycle of the write signal S22 and the cycle of the read signal S23 to simplify the description.

The write data counter 221 and the read data counter 222 are respectively incremented when the write signal S22 and the read signal S23 are asserted. In the present case, because the read signal S23 is asserted more often than the write signal S22, a reading overflow will be sooner or later generated in the data buffer 23. Therefore, when the count value of the differential counter 223 is equal to or less than a certain level, the differential counter 223 outputs the read-over signal S25. The control circuit 224 receives the read-over signal S25 and halts the creation of the buffer read signal S26 to thereby prevent the generation of the reading overflow in the data buffer 23.

Further, the control circuit 224 retains a value last read from the data buffer 23, and then subtracts a certain value from the last read and retained data every time when the read signal S23 is asserted and outputs the subtracted value as the transfer data D23. In the present example, the value subtracted therefrom is “1”. Thereafter, whenever the read signal S23 is asserted, the control circuit 224 outputs the subtracted data while further subtracting only “1” from the subtracted data. In that manner, the output level of the transfer data D23 can be gradually reduced. The audio data, whose output level is gradually reduced, is finally inputted to the D/A converter 52 in the amplifier unit 5 via the network 3. Then, an analogue amplification level of the D/A converter 52 is also gradually reduced, thereby finally resulting in a mute state without the generation of any noise. The generation of the noise sound from the speaker 54 of the amplifier unit 5 can be prevented even if the audio data from the drive unit 1 is interrupted.

At a point E, the count value of the differential counter 223 remains “0” though the count value of the read data counter 222 increases as “2”, “3”, “4”, “5”. Further, it is learnt that the buffer read signal S26 is not created in contrast to the read signal S23 and that the transfer data D23 is decremented by “1” as “D2”→“D2-1”→“D2-2”→“D2-3” every time when the read signal S23 is asserted.

When the transfer data D23 is “0”, the control circuit 224 retains the value of “0” because it would generate an underflow to conduct the subtraction to “0”. For example, when the subtraction data is “001” in the binary notation, “000” is obtained in the first subtraction, and “000” is retained in the second subtraction onward. In the case of a simple subtraction processing, the underflow is generated in the second subtraction with the subtracted data resulting in “111”. When the subtracted data “111” is received by the amplifier unit 5 and analogue-converted by the D/A converter 52, the amplification drastically changes from zero, thereby causing the generation of the noise sound. In order to prevent the foregoing problem from happening, when “000” is once obtained in the subtraction, the value “000” is thereafter retained.

In the interface 24, the transfer data D23 generated in the transfer data creation circuit 22 is converted into a format suitable for the network, and further transmits network data D31 to the network 3.

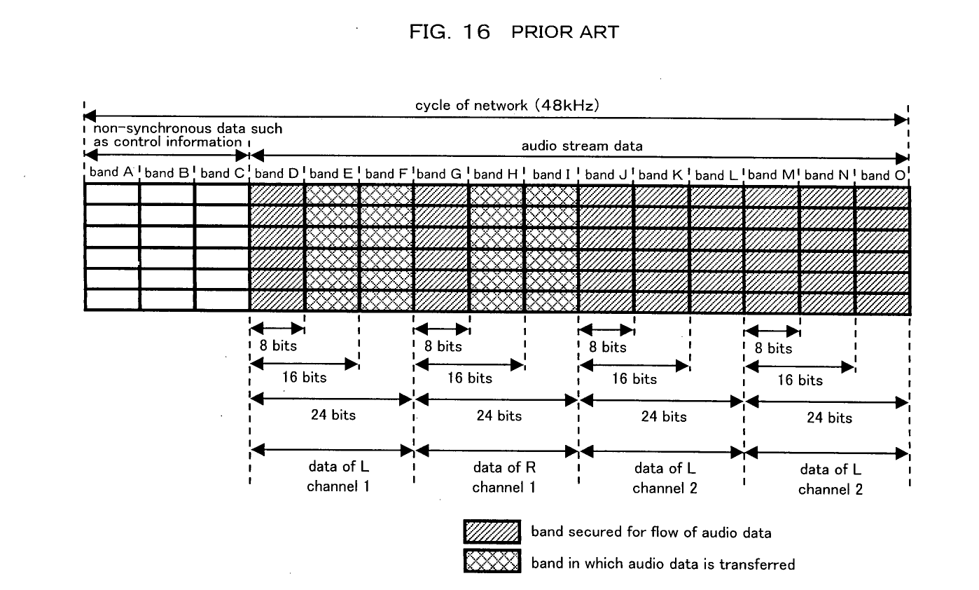

Next, a transmission method for realizing an efficient data transfer in the network 3 is described referring to FIGS. 16, 17, and 18.

FIG. 16 shows a network system where data in the range of bands A-O is transferred in the cycle of 48 kHz. In the bands A-C (band 2), non-synchronous data, such as control data and map information, which is transferred on the demand-basis, is transmitted and received. In the bands D-O (band 1), the audio data is transferred.

FIG. 16 shows a specification enabling the transfer of audio data of 48 kHz, maximum 24 bits and four channels, audio data of 96 kHz, maximum 24 bits and two channels, and audio data of 192 kHz, maximum 24 bits and one channel. The drawing shows the case of transmitting the audio data of 48 kHz in sampling frequency, 16 bits in quantization bit number and two channels. In the drawing, the bands D-O are always secured because those bands are necessarily secured to enable the transfer of the audio data having the maximum bit number and sampling frequency at any time in dealing with the DVD audio having a different quantization bit number and sampling frequency for each music.

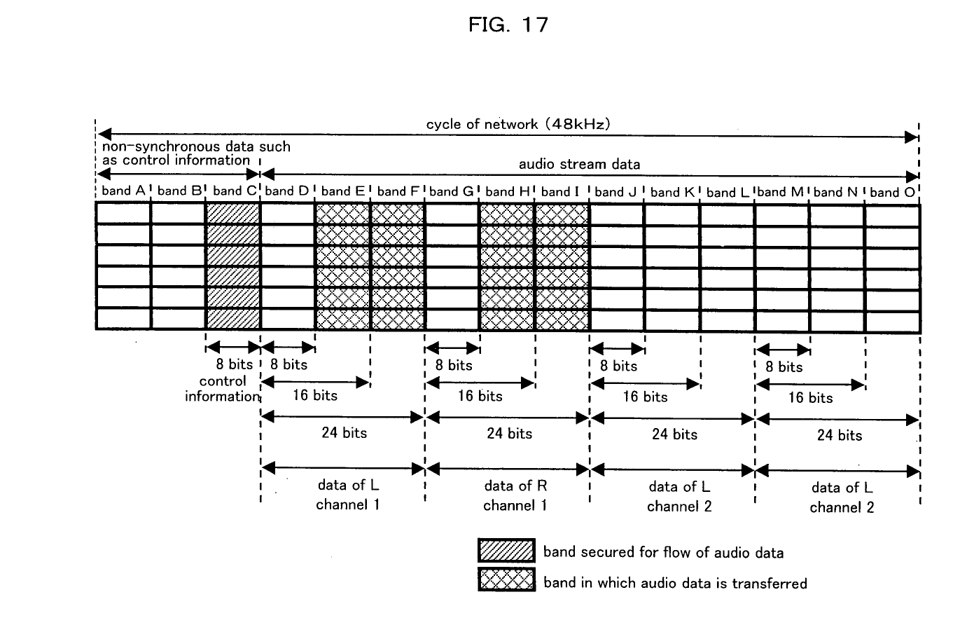

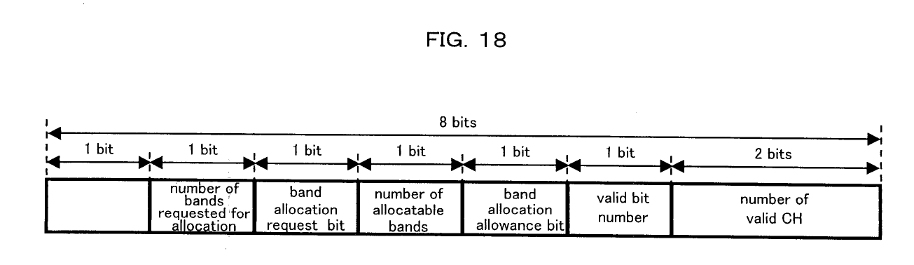

In order to eliminate the need to constantly secure such broad bands, a transmission method, wherein the quantization bit number and/or sampling frequency of the audio data and band information on any unused band and the like are incorporated in the band C so that those informations are transmitted together with the audio data, is available, as shown in FIG. 17. FIG. 18 shows functions incorporated in the band information.

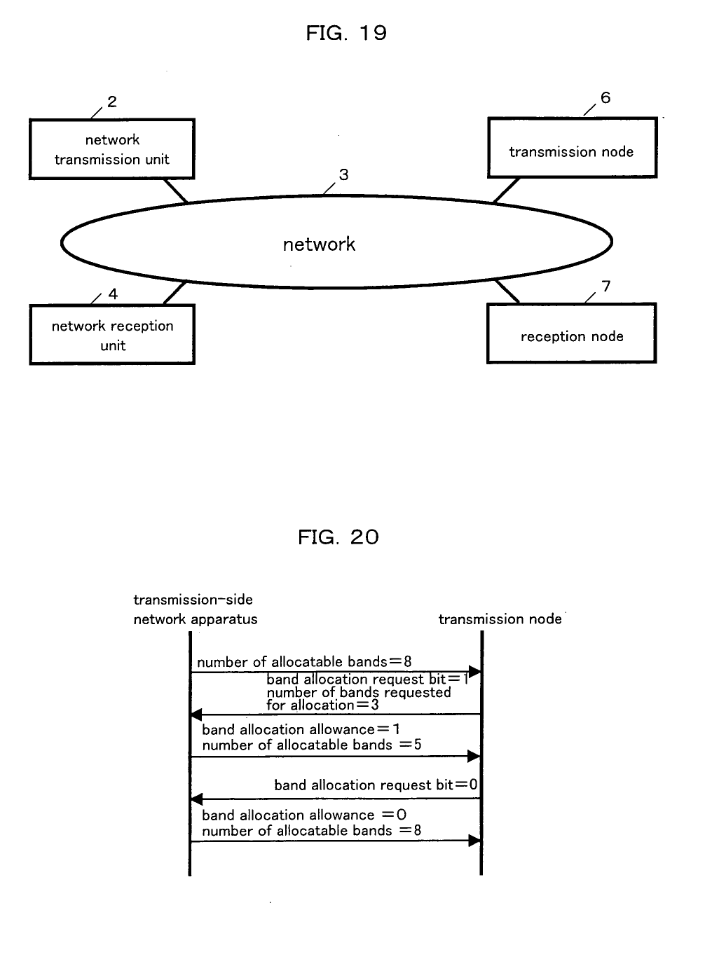

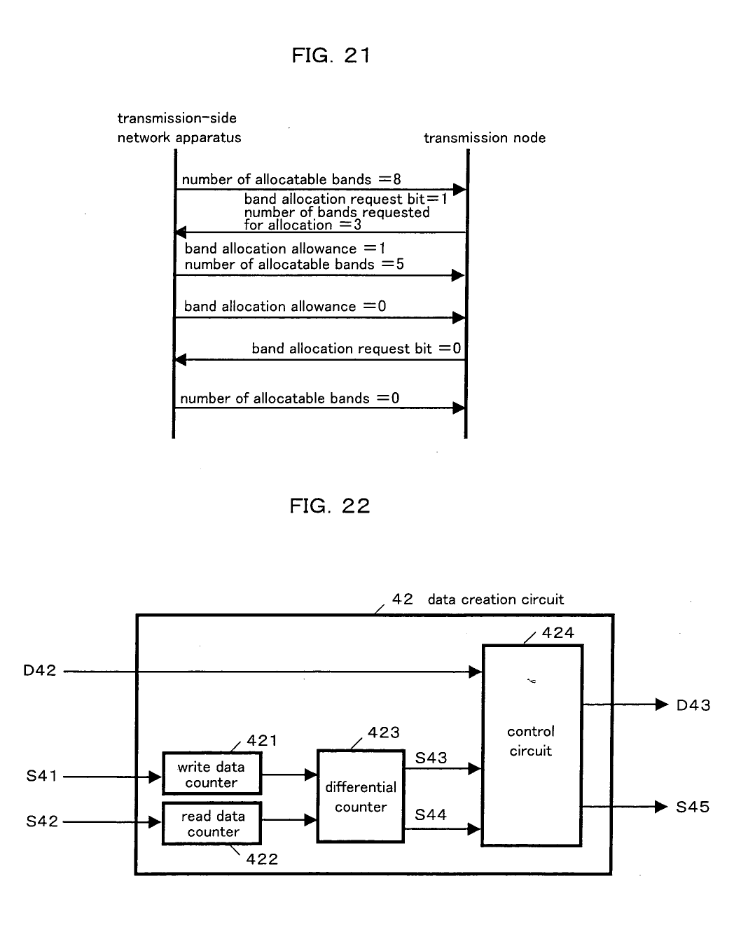

Specific examples of FIGS. 17 and 18 are described referring to FIGS. 19, 20 and 21. In FIG. 19, the network 3 comprises, other than the network transmission unit 2 and the network reception unit 4, a transmission node 6 for transmitting data and a reception node 7 for receiving data. FIGS. 20 and 21 are flow charts of a request for opening the bands made by the transmission node 6 with respect to the network transmission unit 2 in FIG. 19.

In FIG. 20, first, the network transmission unit 2 notifies all of the apparatuses connected to the network 3 of the presence of eight vacancies in the transmission bands of the audio data (see FIG. 17). The number of the allocatable bands, which is “8” in the present example, is transmitted to the network 3. The transmission node 6 receives the number and transmits the number of the bands requested for allocation, which is “3”, and a band allocation request bit, which is “1”, to the network transmission unit 2. The network transmission unit 2 receives the values and correspondingly sets a band allocation allowance bit to “1”, and further transmits the remaining number of the usable bands, which is “5”, as the number of the allocatable bands “5”, to the network 3. The transmission node 6 receives the band allocation allowance bit “1”, and then starts the transmission of the data with respect to the reception node 7. The transmission node 6 sets the band allocation request bit to “0” when the data transmission is completed. The network transmission unit 2 correspondingly sets the band allocation allowance bit to “0” and restitutes the number of the allocatable bands to “8”.

FIG. 21 shows the same process as in FIG. 20 up to the point where the band allocation is allowed. Then, the network transmission unit 2 sets the band allocation allowance bit to “0” before the data transfer by the transmission node 6 is completed so that the request to open the bands is made to the transmission node 6.

The transmission node 6 correspondingly sets the band allocation request bit to “0”, and the network transmission unit 2 sets the number of the allocatable bands to “0” to thereby transfer the audio data. Thus, the transmission bands of the network 3 can be efficiently used.

Next, the network reception unit 4 is described. The interface 41 receives the network data D32 from the network 3 and inversely format-converts the network data D32, and then creates the audio data and the file information. The interface 41 further creates the transfer data D41, in which the audio data and the file information are multiplexed, and the write signal S41 for writing the transfer data D41 in the data buffer 43.

A data creation circuit 42 shown in FIG. 22 comprises a write data counter 421, a read data counter 422, a differential counter 423, and a control circuit 424. The write data counter 421 detects the assertion of the write signal S41 outputted from the interface 41 and counts a volume of the data written in the data buffer 43. The read data counter 422 detects the assertion of the read signal S42 outputted from the serial transmission circuit 44 and counts a volume of the data read from the data buffer 43. The differential counter 423 calculates a differential between the count value of the write data counter 421 and the count value of the read data counter 422. Further, the differential counter 423 asserts the write-over signal S43 when the count value of the write data counter 421 is larger than the count value of the read data counter 422 by a certain level or more, and asserts the read-over signal S44 when the count value of the read data counter 422 is larger than the count value of the write data counter 421. The control circuit 424 inputs the buffer data D42, write-over signal S43, and read-over signal S44, and outputs the data D43 and the buffer read signal S45.

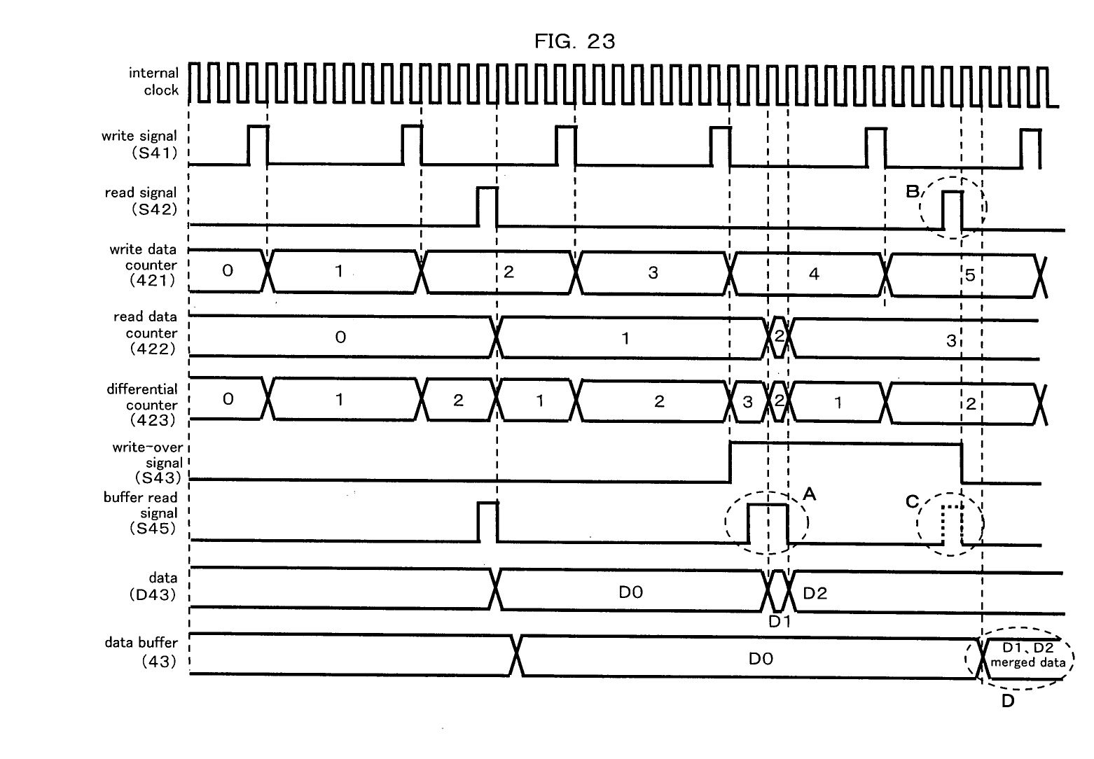

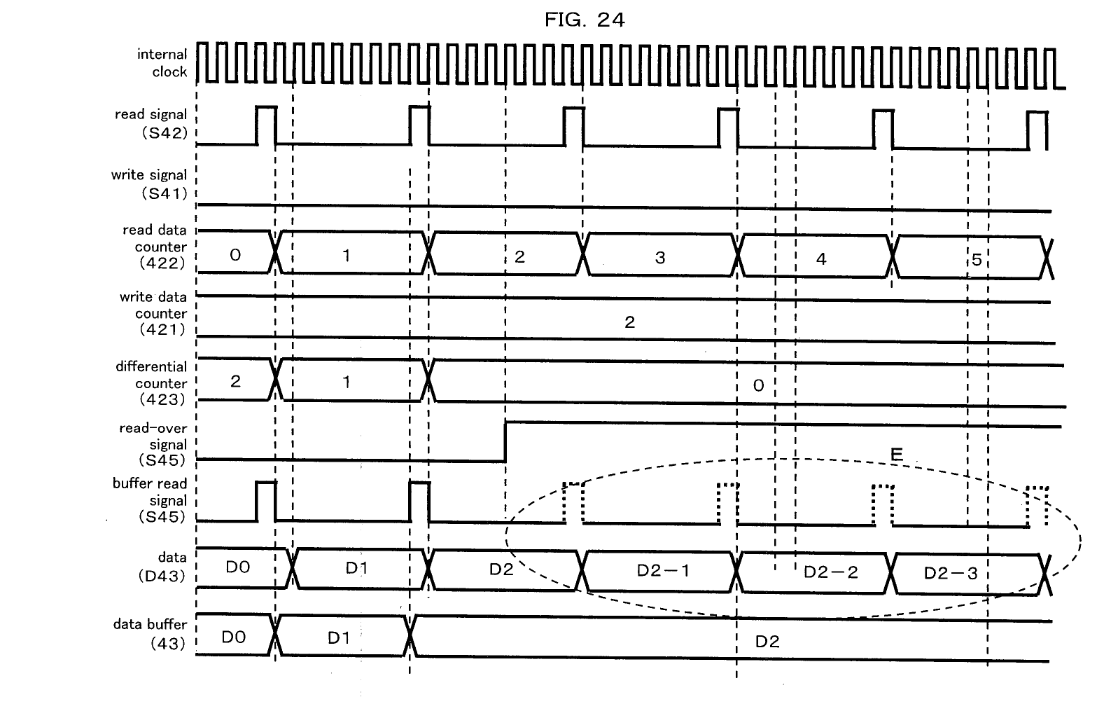

Hereinafter, an operation of the control circuit 424 is described referring to FIGS. 23 and 24. A clock used in the following description is an operation clock of the data creation circuit 42.

FIG. 23 shows the case where a cycle in which the interface 41 writes the data in the data buffer 43 is shorter than a cycle in which the serial transmission circuit 44 reads the data from the data buffer 43. This is the phenomenon generated when there is a variation between a cycle of the transfer clock CK50 created by amplifier unit 5 and the cycle of the clock of the network 3 due to a frequency deviation. The drawing shows the state where there is a large variation between a cycle of the write signal S41 and a cycle of the read signal S42 to simplify the description.

The write data counter 421 and the read data counter 422 are respectively incremented when the write signal S41 and the read signal S42 are asserted. In the present case, the read signal S42 is asserted less often than the write signal S41, which sooner or later leads to the generation of the writing overflow in the data buffer 43. Therefore, when the count value of the differential counter 423 is equal to or more than a certain value, the differential counter 423 outputs the write-over signal S43. The control circuit 424 receives the write-over signal S43, and creates the buffer read signal S45 to thereby read the buffer data D42 from the data buffer 43 and merge the read data. In FIG. 23, when the count value of the differential counter 423 is “3”, the buffer read signal S45 is created and the data buffer is thereby read-accessed twice. A point A shows that two additional buffer read signals S45 are created. In the absence of the read signal S42, the count value of the read data counter 422 proceeds to “2”, “3”, and the count value of the differential counter 423 accordingly decreases to “2”, “1”. Data “D1” and “D2” are read from the data buffer 43. The two data D1 and D2 are summed, and then divided by “2” to be thereafter merged, which means the substantial reduction of the sampling frequency to a half. The method of the merger is not limited to the method described above.

Meanwhile, when the next read signal S42 is asserted at a point B, the merged data is outputted as the data D43 at a point D. At that time, as shown at a point C, the buffer read signal S45 is masked by means of the write-over signal S43 to thereby halt an ordinary data output from the data buffer 43.

Then, the write-over signal S43 is negated in response to the assertion of the read signal S42, thereby returning to a normal operation.

As described, the merger of the audio data substantially reduces the sampling frequency. In that manner, the generation of the writing overflow in the data buffer 23 can be prevented.

FIG. 24 shows the case where the cycle in which the interface 41 writes the data in the data buffer 43 is longer than the cycle in which the serial transmission circuit 44 reads the data from the data buffer 43. This is the phenomenon generated when there is a variation between the cycle of the transfer clock CK50 created by amplifier unit 5 and the cycle of the clock of the network 3 due to a frequency deviation. The same phenomenon occurs when it becomes impossible for the network data D32 to be received from the network 3 due to a network failure or the like. The drawing shows the state where there is a large variation between a cycle of the write signal S41 and a cycle of the read signal S42 to simplify the description.

The write data counter 421 and the read data counter 422 are respectively incremented when the write signal S41 and the read signal S42 are asserted. In the present case, the read signal S42 is asserted more often than the write signal S41, which sooner or later leads to the generation of the reading overflow in the data buffer 43. Therefore, when the count value of the differential counter 423 is equal to or less than a certain value, the differential counter 423 outputs the read-over signal S44. The control circuit 424 receives the read-over signal S44 and correspondingly halts the creation of the buffer read signal S45 to thereby prevent the generation of the reading overflow in the data buffer 43.

Further, the control circuit 424 retains a value last read from the data buffer 43, and further subtracts a certain value from the last read and retained data every time when the read signal S42 is asserted and outputs the subtracted data as the data D43. In the present case, the value subtracted therefrom is “1”. Thereafter, whenever the read signal S42 is asserted, the control circuit 424 outputs the subtracted data while further subtracting only “1” from the subtracted data. In that manner, the output level of the data D43 can be gradually reduced. The audio data, whose output level is gradually reduced, is finally inputted to the D/A converter 52 in the amplifier unit 5. Then, the analogue amplification level of the D/A converter 52 is also gradually reduced, thereby finally resulting in the mute state without the generation of any noise. Thus, the generation of the noise sound from the speaker 54 of the amplifier unit 5 can be prevented even if the audio data from the network 3 is interrupted.

At a point E, the count value of the differential counter 423 remains “0” though the count value of the read data counter 422 is increased as “2”, “3”, “4”, “5”. Further, it is learnt that the buffer read signal S45 is not created in contrast to the read signal S42 and that the data D43 is decremented by “1” every time when the read signal S42 is asserted.

The control circuit 424 retains the value of “0” when the data D43 reaches “0”, which is the same as in the description of the control circuit 224.

The communication data D50, in which the audio data and the file information are multiplexed, is transmitted from the serial transmission circuit 44. The specific configuration of the serial transmission circuit 44 is identical to that of the serial transmission circuit 13.

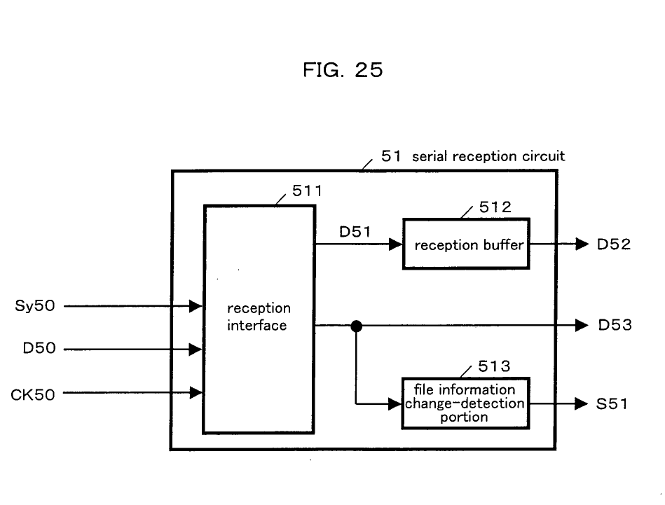

Next, the amplifier unit 5 is described. A serial reception circuit 51 shown in FIG. 25 comprises a reception interface 511, a reception buffer 512, and a file information change-detection portion 513. The reception interface 511 inputs the communication data D50 outputted from the network reception unit 4 and divides the communication data D50 into the audio data D51 and the file information D53 (quantization bit number and sampling frequency). The audio data D51 is stored in the reception buffer 512, and is further read constituting the audio data D52. The file information change-detection portion 513 is a circuit for asserting a change-detection signal S51 when the quantization bit number and/or the sampling frequency in the file information D53 changes, and the change-detection signal S51 is asserted until the setting change of the file information by the D/A converter 52 is completed. During the time when the change-detection signal S51 is asserted, the level control circuit 53 halts or largely attenuates the output of the D/A converter 52, therefore no noise sound is generated from the speaker 54.

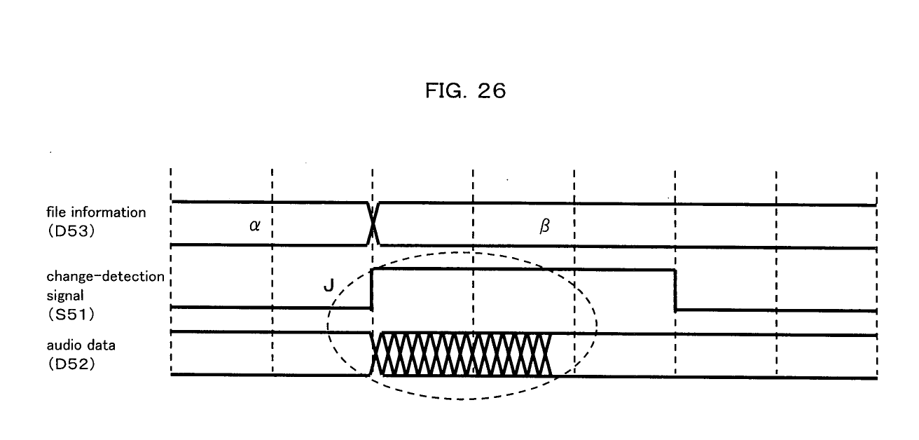

FIG. 26 is a time chart at the time of the setting change by the D/A converter 52. It is shown that the generation of the noise sound from the speaker 54 is prevented at a point J.

As described, even when the quantization bit number and/or the sampling frequency is changed, the audio data can be seamlessly reproduced, and further, the generation of the noise sound can be prevented even when the audio data is interrupted.

Embodiment 2

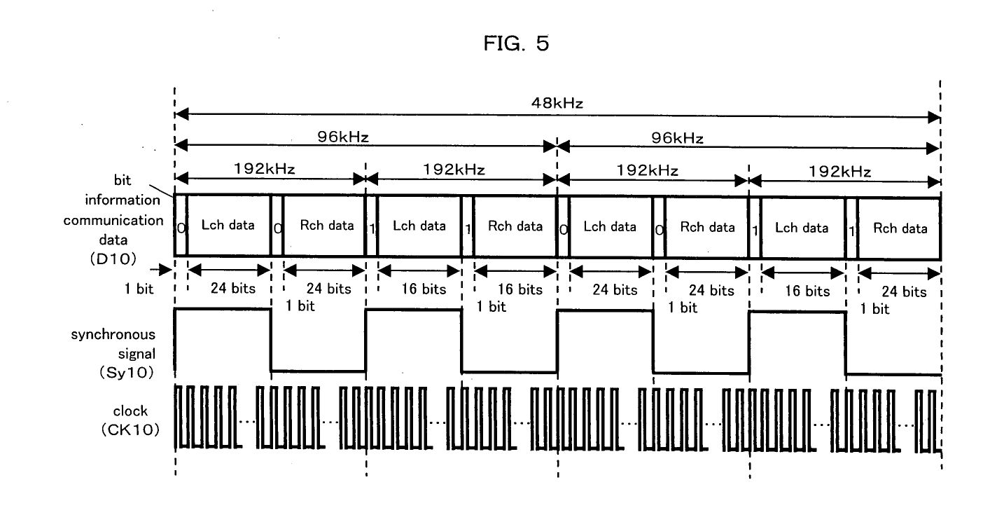

An embodiment 2 of the present invention is identical to the embodiment 1 except for a signal outputted from the serial transmission circuit 13. Hereinafter, the embodiment 2 is described referring to FIG. 5.

In the embodiment 1, the data transmission is executed with uniformly fixed 24 bits in quantization bit number, which, however, raises the problem that power is inefficiently consumed.

In FIG. 5, bit information is incorporated into the communication data D10 to thereby achieve the control of the power consumption. In the present case, “0” in the case of the quantization bit number being 24 bits and “1” in the case of the quantization bit number being 16 bits are respectively incorporated into the communication data. In FIGS. 3 and 5, the identical audio data is transmitted. FIG. 3 shows the transmission in total 192 bits calculated from 24 bits×8, while FIG. 5 shows the transmission in total 168 bits calculated from ((24 bits×4)+(16 bits×4)+8), in which the power consumption can be reduced by means of the clock CK10 and the like.

Embodiment 3

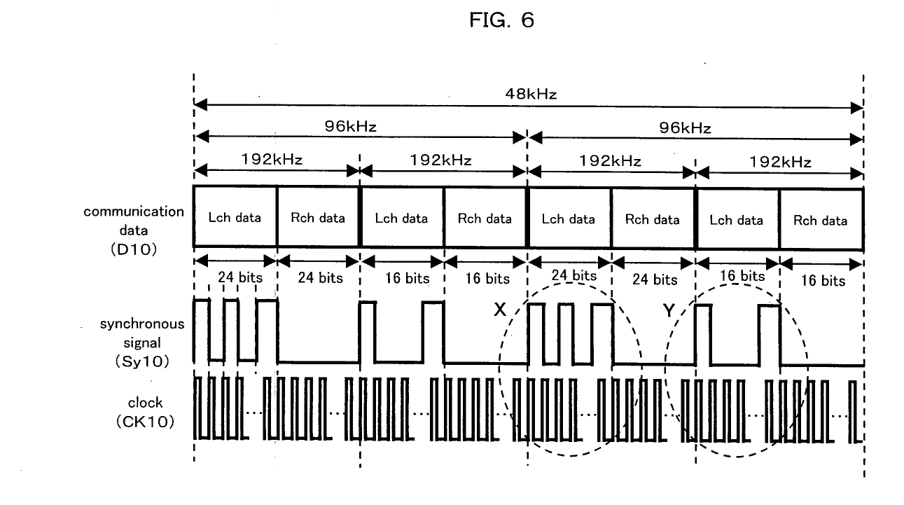

An embodiment 3 of the present invention is identical to the embodiment 1 except for a signal outputted from the serial transmission circuit 13. Hereinafter, the embodiment 3 is described referring FIGS. 6, 7, and 8.

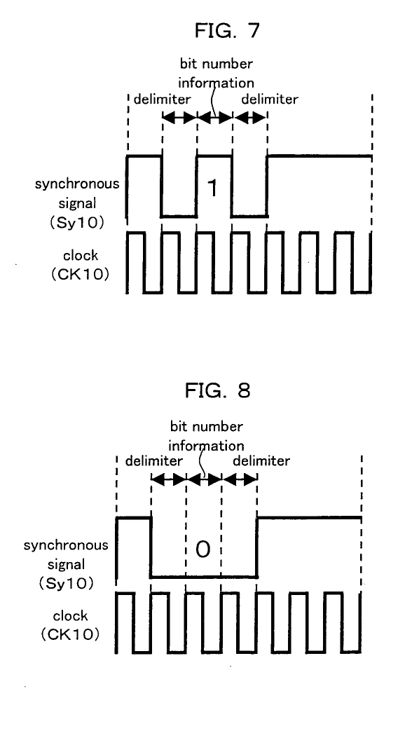

In the embodiments 1 and 2, the correction data, the bit information, or the like, is incorporated into the communication data D10 to thereby execute the multiplexed data communication. However, this is practically the addition of the data other than the audio data to be primarily transmitted, which is, therefore, inefficient. In order to solve the problem, as shown in FIG. 6, the data communication is executed by incorporating information on the quantization bit number into the synchronous signal Sy10. More specifically, as shown in FIGS. 7 and 8, the bit number information of a bit sandwiched by delimiters at a L level is incorporated into the synchronous signal Sy10, which originally changes only in response to a switchover between the L channel data and the R channel data, to thereby transmit the quantization bit number to a reception side. In the present case, when the bit number information is “1”, the audio data of 24 bits is transferred (see point X), and when the bit number information is “0”, the audio data of 16 bits is transferred (see point Y). As described, the bit number information is incorporated into the synchronous signal Sy10 to thereby realize the seamless communication of the audio data without reducing the transmission efficiency.

Embodiment 4

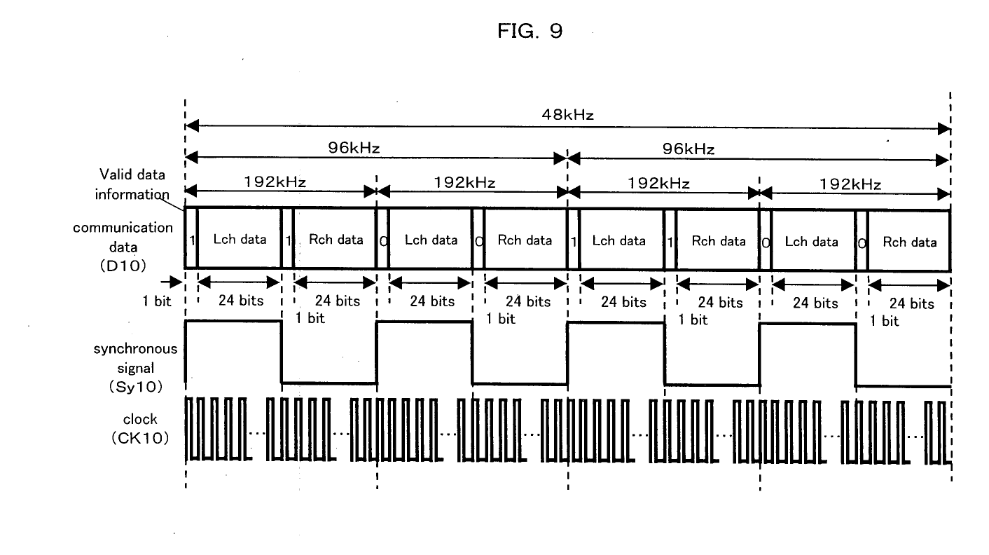

An embodiment 4 of the present invention is identical to the embodiment 1 except for a signal outputted from the serial transmission circuit 13. Hereinafter, the embodiment 4 is described referring FIG. 9.

In FIG. 9, valid data information is incorporated into the communication data D10 so as to make the sampling frequency variable. The audio data is handled as valid data when a valid data information bit is set to “1”, and as invalid data when the valid data information bit is set to “0”. In the present case, the audio data of the L and R channels is outputted in the cycle of 192 kHz. The valid data information is “1” respectively twice in the L-channel data and once in the R-channel data, which means that the audio data of 96 kHz is outputted. In the network interface, the valid data information is monitored and only the bands necessary for the data transfer are utilized to thereby improve the transmission efficiency in the entire network 3.

Embodiment 5

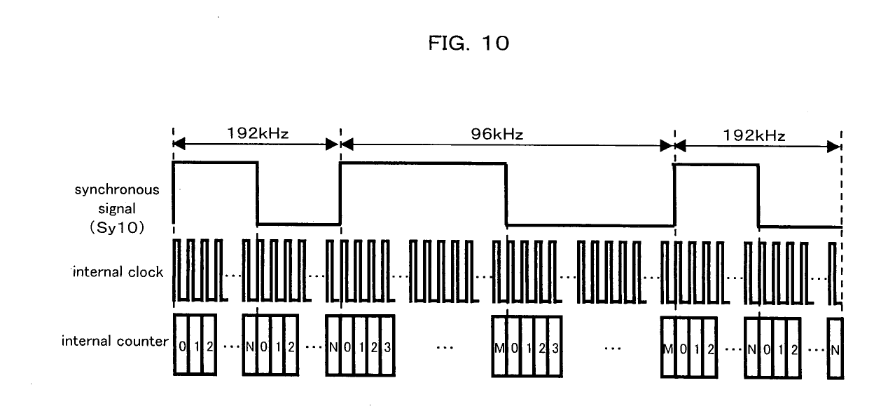

An embodiment 5 of the present invention is identical to the embodiment 1 except for a signal outputted from the serial transmission circuit 13. Hereinafter, the embodiment 5 is described referring FIG. 10.

In FIG. 10, the sampling frequency is detected by sampling a cycle of the synchronous signal Sy10 by means of an internal clock of the serial reception circuit 21, and only the bands necessary for the data transfer are utilized. The transmission efficiency in the entire network 3 can be thus improved.

Embodiment 6

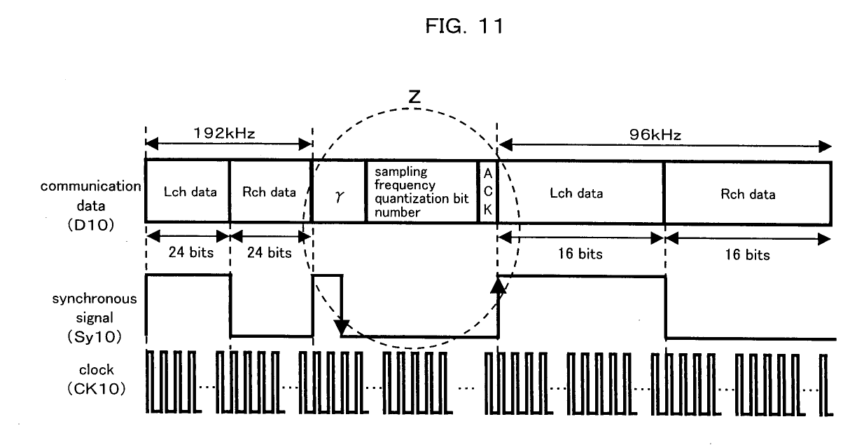

An embodiment 6 of the present invention is identical to the embodiment 1 except for a signal outputted from the serial transmission circuit 13. Hereinafter, the embodiment 6 is described referring FIG. 11.

In FIG. 11, when the quantization bit number and the sampling frequency are changed over, a signal level of the synchronous signal Sy10 is inverted in a short cycle to thereby notify the serial reception circuit 21 of the setting change. At that time, in the case where the serial reception circuit 21 runs short of the audio data, correction audio data is created to avoid the generation of the missing sound in the transfer data creation circuit 22. At a point Z in FIG. 11, a part marked with “γ” in the communication data D10 denotes ignorable data. Thereafter, the file information such as the quantization bit number and the sampling frequency is transmitted from the serial transmission circuit 13 to the serial reception circuit 21, and the serial reception circuit 21 correspondingly sends an “ACK” bit representing the completion of the data reception to the serial transmission circuit 13. When the foregoing continuous processing is completed, the communication of the multiplexed data is restarted between the serial transmission circuit 13 and the serial reception circuit 21. Thus, the transmission efficiency in the entire network 3 can be improved by changing the setting in the data communication every time when the quantization bit number or the sampling frequency is changed.

As described, according to the present invention, when the audio data is transmitted/received via the network, the transmission of the audio data is not necessarily halted every time when the quantization bit number and/or the sampling frequency of the audio data is changed. The audio data can be still seamlessly reproduced through the seamless transmission. The data can be more efficiently transmitted. Further, in the case where the drive unit or the amplifier unit is not entirely in synchronization with the data transfer cycle or any communication failure is generated in the network, the audio data can be correctly transmitted/received between the drive unit and the amplifier unit while preventing any noise sound such as the missing sound from the speaker of the amplifier unit.

Further, as a possible data transmission method, the file information of the audio data (qunatization bit number and/or sampling frequency) is embedded in a part of the band 2 for transmitting/receiving the control data for among the apparatuses connected on the network, apart from the audio data in the band 1 for transmitting/receiving the audio data, and the audio data of the band 1 and the file information of the band 2 are simultaneously transmitted to thereby make a real-time change to the band 1 necessary in accordance with the file information. Thereby, the data transmission efficiency in the entire network can be improved.

The technology according to the present invention is effective in seamlessly transmitting and reproducing contents data, preventing a sound jump, and the like, in an audio system, or the like, wherein a drive unit for reproducing audio data, such as DVD audio, having a different quantization bit number and/or sampling frequency for each contents and a amplifier unit provided with a D/A converter, amplifier, speaker, and the like, are connected via a network.

The present invention is not limited to the embodiments thus far described, and realizable in different modifications within the true spirit and scope of the invention.

1. An audio system comprising:
a drive unit for reading audio data and file information including a quantization bit number and a sampling frequency from a recording medium, multiplexing the read audio data and file information, and serially outputting the multiplexed data;
a network transmission unit comprising a function for creating network data by converting the multiplexed data serially inputted from the drive unit into a required transfer format and transmitting the network data to the network, the network transmission unit further comprising a function for verifying a variation between a cycle of the reception from the drive unit and a cycle of the transmission to the network and automatically correcting the variation between the cycles when the presence of the variation is detected;
a network reception unit comprising a function for creating multiplexed data by inversely format-converting the network data received from the network transmission unit and serially outputting the multiplexed data, the network reception unit further comprising a function for verifying a variation between a cycle of the reception from the network and a cycle of the transmission of the multiplexed data and automatically correcting the variation between the cycles when the presence of the variation is detected; and
an amplifier unit for dividing the multiplexed data serially inputted from the network reception unit into the audio data and the file information, converting the audio data into an analogue signal, verifying a change of the file information, and reducing an analogue output level until the completion of a setting change of the file information when the presence of the change is detected.

2. An audio system as claimed in claim 1, wherein
the network transmission unit is configured in such manner as format-converting the audio data and the quantization bit number to thereby create network data and correcting the audio data and the quantization bit number when a variation is generated between input and output cycles.

3. An audio system as claimed in claim 1, wherein
the network transmission unit is configured in such manner as format-converting the audio data and the sampling frequency to thereby create network data and correcting the audio data and the sampling frequency when a variation is generated between input and output cycles.

4. An audio system as claimed in claim 1, wherein
the network transmission unit is configured in such manner as format-converting the audio data, the quantization bit number, and the sampling frequency to thereby create network data and correcting the audio data, the quantization bit number, and the sampling frequency when a variation is generated between input and output cycles.

5. An audio system as claimed in claim 1, wherein
the network transmission unit is configured in such manner as creating correction audio data when the serial input of the multiplexed data from the drive unit is halted.

6. An audio system as claimed in claim 1, wherein
the network transmission unit has a function for detecting the sampling frequency of the audio data inputted from the drive unit.

7. An audio system as claimed in claim 1, wherein
the network reception unit is configured in such manner as receiving the audio data and the quantization bit number from the network as the network data and correcting the audio data and the quantization bit number when a variation is generated between input and output cycles.

8. An audio system as claimed in claim 1, wherein the network reception unit is configured in such manner as receiving the audio data and the sampling frequency from the network as the network data and correcting the audio data and the sampling frequency when a variation is generated between input and output cycles.

9. An audio system as claimed in claim 1, wherein
the network reception unit is configured in such manner as receiving the audio data, the quantization bit number, and the sampling frequency from the network as the network data and correcting the audio data, the quantization bit number, and the sampling frequency when a variation is generated between input and output cycles.

10. An audio system as claimed in claim 1, wherein
the network reception unit is configured in such manner as creating correction audio data when the reception of the network data from the network is halted.

11. An audio system as claimed in claim 1, wherein
the amplifier unit is configured in such manner as creating the audio data and the quantization bit number from the multiplexed data received from the network reception unit, converting the audio data into an analogue signal, verifying a change of the quantization bit number, and reducing an analogue output level until the completion of a setting change of the quantization bit number when the presence of the change is detected.

12. An audio system as claimed in claim 1, wherein
the amplifier unit is configured in such manner as creating the audio data and the sampling frequency from the multiplexed data received from the network reception unit, converting the audio data into an analogue signal, verifying a change of the sampling frequency, and reducing an analogue output level until the completion of a setting change of the sampling frequency when the presence of the change is detected.

13. An audio system as claimed in claim 1, wherein
the amplifier unit is configured in such manner as creating the audio data, the quantization bit number, and the sampling frequency from the multiplexed data received from the network reception unit, converting the audio data into an analogue signal, verifying a change of the quantization bit number or the sampling frequency, and reducing an analogue output level until the completion of a setting change of the quantization bit number or the sampling frequency when the presence of the change is detected.

14. An audio system as claimed in claim 1, wherein
the network transmission unit is configured in such manner as operating according to a data transmission system, wherein the file information (quantization bit number and/or sampling frequency) of the audio data is embedded in a part of a band 2 for transmitting/receiving control data for among apparatuses connected on the network apart from audio data of a band 1 for transmitting/receiving the audio data, and the audio data of the band 1 and the file information of the band 2 and are simultaneously transmitted to thereby make a real-time change to the band 1 necessary in accordance with the file information.
